(19) United States
(12) Patent Application Publication
(10) Pub. No.: US 2023/0264443 A1
(43) Pub. Date: Aug. 24, 2023

(54) Pre-Vulcanised Annular Crown Of Ultra-Large Tyre And Preparation Method Therefor And Application Thereof

(71) Applicant: BEIJING DUBELI TYRE CO., LTD., Beijing (CN)

(72) Inventors: Xiaojun ZHU, Beijing (CN); Tianlin YAO, Beijing (CN); Jian ZHU, Beijing (CN); Shixing ZHU, Beijing (CN)

(21) Appl. No.: 18/017,964

(22) PCT Filed: Jul. 19, 2021
(86) PCT No.: PCT/CN2021/107091

§ 371 Date: Jan. 25, 2023

(30) Foreign Application Priority Data
Jul. 30, 2020 (CN) 202010748533.3

(51) Int. Cl. B29D 30/06; B29D 30/54; B60C 11/01

(52) U.S. Cl. CPC B29D 30/0605; B29D 30/54; B60C 11/01; B60C 2011/013

(57) ABSTRACT

The present invention relates to a pre-vulcanized annular crown of an extra-large tire, and a preparation method and an application thereof. The annular crown includes shoulder extending edges, which extend from both sides of the crown to the central direction of the tire along shoulders, where the shoulder extending edges are provided with a structure of pattern blocks and pattern grooves, which extend from a tread to sidewalls and are suitable for the extra-large tire, and outer contour lines of sections of the shoulders and the shoulder extending edges are concave inwards. Pattern grooves in original shoulders can be completely removed when an old tire body is ground, and the crown structure and functional advantages of the extra-large tire which is retreaded can be fully given.

### TECHNICAL FIELD

The present invention relates to the technical field of pre-vulcanized crowns, in particular to a pre-vulcanized annular crown of an extra-large tire and its application. BACKGROUND

The so-called extra-large tire refers to the division of tire size in the tire appearance quality standard “HG/T2177-2011” of the chemical industry standard of the People's Republic of China. Pneumatic tires with a nominal diameter of 33 inches and above of the rim and a nominal width of 24 inches and above of the section are extra-large tires. At the same time, according to the generally recognized concept put forward by the China Rubber Association: engineering tires with the nominal outer diameter of the rim of the tire specification of 33 inches and above, the outer diameter of the tire design more than 2,000 mm, and the load capacity of a single tire (★★ class, 10 km/h) more than 20,000 kg are giant tires. At present, tires that meet the requirements of this specification are mainly used for large mining vehicles and engineering vehicles on non-paved roads, and are collectively referred to as extra-large tires hereinafter. For example, an extra-large tire with a tire specification of 59/80R63 has a diameter of about 4,000 mm, a weight of 5.5 tons per tire, an import value of about US $100,000, and an average service life of about 4,000 to 5,000 hours.

Extra-large tires are mainly used for work vehicles on non-paved roads. Due to the extremely poor road environment of various engineering work sites, there are often various obstacles such as sundries and gravel, which will cause great damage to the tires. Because of harsh environment, the tires often work under full load with low traveling speed, but a large load-bearing torque and the maximum static load of a single tire reaching 90 tons, thus the tires are required to have better wear resistance and puncture resistance. Wide and thick carcasses and treads thereof are not conducive to heat dissipation, so that extra-large tires are required to have deeper and wider pattern grooves to improve the heat dissipation performance of the tires.

The extra-large tires are most widely used in open-pit mines. As the demand for mineral resources continues to grow, in order to improve mining efficiency and reduce costs, various large-scale open-pit mines are increasingly using large-scale mine-specific vehicles, with a load capacity ranging from 45 to 320 tons and above and a maximum vehicle weight of up to 550 tons, which needs to be equipped with extra-large tires. The road on which mining vehicles travel needs to change with the change of the location of the mine lode and the discharge yard. The road foundation is difficult to be compacted thoroughly, resulting in uneven road surface and many sediments and sewage. There will be a large number of scattered ore fragments with sharp and pointed edges and corners in the loading and unloading face and road surface during operation, which causes various damages to the tires of the vehicle, mostly in the form of thorns, punctures, cuts and other damage wounds of different sizes. Under the multiple effects of harsh environmental climate and road conditions, heavy-duty extra-large tires have a high probability of causing direct puncture and damage to the tread rubber and belt steel wire structure. If a tire is punctured and severely leaks air, the driver can find out in time and report it to the maintenance personnel for processing. However, most of the wounds will not leak air immediately and the tire can continue to drive normally, but the damaged steel wire is exposed to air and muddy water, which is prone to rust and gradually spreads around the belt steel wire. When traveling, the tire is constantly rolling, crushing, bending and deforming, and the internal rubber and the rusted belt steel wire are constantly rubbing against each other to generate high temperature heat, which will cause the rubber and the belt steel wire to age and separate rapidly, resulting in the carcass, tread and belt steel wires being gradually voided or stripped and scrapped.

Due to the huge volume of extra-large tires and high production technology content, only a few foreign manufacturers monopolize production at present, and the brands available to mines are extremely limited, resulting in long-term high prices of extra-large tires at home and abroad. China also strongly encourages domestic tire companies to develop and trial-produce tires, but the current domestic products have a very short service life and cannot meet the needs of mines. In order to reduce the use cost of extra-large tires, mining enterprises have been looking for various ways to reduce costs for many years. At present, the most effective method recognized by mining enterprises is to use the original value of the old carcass of mature products of extra-large tires, and recycle same through retreading, which can significantly reduce the overall cost of tire use.

According to the cost calculation and analysis of the new tire manufacturing industry, the crown accounts for 25-30% of the comprehensive cost of each tire, and the remaining carcass and other parts account for 70-75%. That is, when the tread rubber pattern of a tire is worn out, the tire is scrapped, which is equivalent to wasting 70-75% of the original value of the tire; if it is reused after retreading, the manufacturing cost will only account for 30-35% of the new tire cost, production pollution emission is reduced by 65%, and the service life can reach 95-100% of a new tire. Moreover, the price of extra-large tires is very high, and the cost of tire use on large open-pit mine vehicles accounts for 35% of the total transportation cost, second only to the cost of fuel. Therefore, the technology of extra-large tire retreading and reuse has particularly significant economic benefits for mining enterprises and society.

At present, the following three technical processes are basically used at home and abroad in the technical process of extra-large tire retreading:

1. Model retreading technology (hot retreading): after an old carcass to be retreaded is processed by grinding and other processes, tread raw rubber is spread on the carcass, a mold with pattern blocks is used to heat and pressurize, and tread patterns are formed when vulcanized.

2. Pre-vulcanized retreading technology (cold retreading): firstly, the tread raw rubber is vulcanized separately by heating and pressing by means of a flat vulcanizing machine with a pattern mold to pre-make the vulcanized tread and pattern rubber, including strips, blocks, rings and other types. After the old carcass to be retreaded is processed by grinding and other processes, middle pad rubber is spread on the carcass and the pre-vulcanized tread pattern rubber is pasted, and after the special tire cavity capsule and rim are arranged and the outer envelope is sealed, the tire with the pre-vulcanized tread is formed by heating, pressurization and vulcanization by entering a vulcanizing tank.

3. Carving retreading technology: after the old carcass to be retreaded is processed by grinding and other processes, the tread raw rubber is re-spread or wound on the carcass, the tread patterns are formed by pattern engraving technology, and without installing other auxiliary accessories, the tire is formed by heating, pressurization and vulcanization by entering the vulcanizing tank.

For the retreading of extra-large tires, the above-mentioned technical processes have been applied. However, based on the product characteristics and service environment characteristics of extra-large tires, the existing retreading technology has the following disadvantages:

1. Among them, during the production of the model retreading technology, the discharge of sewage, waste gas and dust is large, and the cost of purification treatment is high. Constrained by technical processes, the production process has a low degree of automation and high labor costs. Model retreading is to heat and pressurize the tread rubber and the vulcanized carcass together, where the carcass is in a high temperature environment for a long time. In this environment, applying high pressure can destroy the internal structure of the rubber and radial steel wire. Simultaneously for avoiding damaging the carcass, tread rubber vulcanization pressure can only be limited, causing deficiency of stabbing resistance and wear-resistant performance of tread rubber. The model retreading technology has strict requirements on the old tires used for retreading that if there is corrosion damage to more than two layers of belt steel wires, or there are multiple damages to belt steel wires with the distance between the damage points smaller than the width of the section of the tire, the tire cannot be retreaded and reused, and the proportion of old tires that can reach the retreading standard is only 2-3%.

2. Comparing the pre-vulcanized retreading technology with the model thermal retreading technology, the tread is pre-vulcanized separately, which can increase the density of the tread rubber by increasing the vulcanization pressure, improve the product's stab resistance and wear resistance, and reduce the pollution processing cost during the production process. However, the existing pre-vulcanized retreading technology has the following problems:

Among them, the strip-shaped and block-shaped pre-vulcanized tread rubber is made by a flat vulcanizing machine, and the pasting surface with the carcass is flat or approximately flat. The existing annular tread rubber is formed into a ring on the basis of a strip, and the inside surface is cylindrical or nearly cylindrical. As shown in FIG. 8, two structures A and B are typical cross-sectional structures presented by the existing pre-vulcanized tread. In order to match the size of the pasting surface of the tread rubber, the residual patterns at the shoulders of the old carcass after grinding cannot be completely removed. As shown in FIG. 9, A is the section of the old tire, in which in two parts separated by a tire grinding reference line, the upper part is the damaged part that needs to be removed before retreading, and the lower part is the carcass part that needs to be retained. Moreover, due to the variety and inconsistent wear, the patterns of the old carcass cannot completely correspond to the patterns of the tread rubber, resulting in different depths of pattern grooves and dislocation of patterns at the junction of the tread rubber and the old carcass, and forming pasting gaps in the tread rubber. As shown in B in FIG. 9, various gaps surrounding must be eliminated by grinding and filling raw rubber. Although the filled rubber has filling and aesthetic effects in appearance, its density and bonding strength are too low, and the shoulder thickness is also increased, so that the performance and heat dissipation of the tire are seriously reduced, and the filling parts are prone to cracking and falling off when the tire rolls under heavy load to crush shoulders and sidewalls.

The pre-vulcanized retreading has stricter requirements on the old carcass than the model retreading that the tire cannot be retreaded and reused if any situation follows occurs that when there is corrosion damage to more than one layer of belt steel wires, the distance among multiple damages to the belt steel wires is less than the width of the section of the tire, and many shoulder blocks come off, so that the ratio of old tires that can reach the retreading standard is at 1-2%.

3. Compared with the model thermal retreading and pre-vulcanized retreading technology, the carving retreading process reduces the investment in retreading equipment, eliminates the use of molds and auxiliary fixtures, and simplifies the production process. However, without being extruded through a mold, physical properties of the carcass and the new tread rubber are poor, and density of the tread rubber is low, resulting in poor stab resistance and wear resistance. Carving retreading of the old carcass is required to be similar to pre-vulcanized retreading that the tire cannot be retreaded and reused when there is corrosion damage to one layer of belt steel wires, the distance among multiple damages to the belt steel wires is less than the width of the section of the tire, and many shoulder blocks come off, so that the ratio of old tires that can reach the retreading standard is at 1-2%.

In addition, there are currently some relatively mature technologies for small-sized tires used in cars and general trucks. However, due to different tire use environments, the design principles of tire structure and appearance are quite different, and therefore none of the small-sized tires can adapt to unique deep pattern and wide pattern tread characteristics of extra-large tires on non-paved roads, and are not suitable for extra-large tires with large volume and heavy load.

Based on the reality of the special use environment of extra-large tires, the number of old carcass that can be retreaded and reused is extremely small and in short supply, and the carcass that can reach the retreading standard of the prior art has only about 2-3%. At present, how to increase the recycling ratio of old carcass, improve the product performance of retreaded tires, and reduce the overall use cost of tires are the biggest problems plaguing mining enterprises.

Annular crown section refers to a section formed by cutting a plane passing through the centerline of rotation of the ring, hereinafter referred to as section.

The following nouns are defined in the national standard GB/T6326-2014 “Tire Terms and Definitions”: crown, shoulder, tread and belt.

### SUMMARY

In order to solve the defects of the existing technology of retreading extra-large tires such as low proportion of old carcass reuse and poor performance of retreaded tires, the present invention provides a pre-vulcanized annular crown of an extra-large tire, which can solve the above-mentioned deficiencies in the current extra-large tire retreading technology.

A pre-vulcanized annular crown of an extra-large tire includes an annular crown, and shoulder extending edges extending from both sides of the crown to the central direction of the tire along shoulders, wherein the shoulder extending edges are provided with a structure of pattern blocks and pattern grooves, which extend from a tread to sidewalls and are suitable for the extra-large tire, and outer contour lines of sections of the shoulders and the shoulder extending edges are concave inwards

Preferably, the shape of the section on the inner surface of the annular crown is a curve composed of multiple segments of tangent arcs, or a straight line segment with multiple segments of arc in the middle and the ends of the shoulder extending edges tangent to the arc, that is, the inner surface is an annular curved surface with multiple tangent curves rotating around the axis.

Preferably, the arc radius of the inner surfaces of the shoulder extending edges is 100-350 mm, the ends of the shoulder extending edges are blunt ends formed by a straight line or an arc, and the thickness of the blunt edges is 3-10 mm.

Preferably, the width range of a traveling surface of the annular crown is more than 500 mm, the arc radius of the traveling surface of the annular crown is more than 2,000 mm, and the thickness of the annular crown is 100 mm-250 mm.

Preferably, the annular crown is provided with cooling grooves on the surface of the pattern blocks at the shoulders.

Preferably, multiple sensor installation blind holes are distributed on the surface of tread rubber of the annular crown, and the bottom ends of the blind holes are located between a primer and belts.

Preferably, the annular crown includes tread rubber, the primer, and belts. Further preferably, the annular crown also includes one or more of the following rubber layers: belt interlayer, belt primer, and shoulder pad.

Further preferably, the maximum width of the belts is less than 90% of the width of the traveling surface, the number of layers of steel cords in the belts is 3-6, the acute angle formed by the steel wire of each layer of cords and the circumferential center line of the tire is 2°-35°, and the directions of the angles between the steel wires of two adjacent cord layers are opposite.

Preferably, the section height of the annular crown is 1.5-2.5 times the central thickness of the annular crown.

Preferably, the total width of the annular crown is 1.02-1.15 times the width of the traveling surface.

A method for preparing the above-mentioned pre-vulcanized annular crown of an extra-large tire includes the following steps:

measuring a new crown structure of a tire to be retreaded to obtain the main size of the tire and the characteristic size of the crown;

designing the structural components and dimensions required for the crown according to the obtained shape and size, planning the layout of the tread patterns and shoulder extending edge patterns, and designing and manufacturing a vulcanization mold with patterns;

using molding equipment to build an annular crown structure, laying each layer of structural materials in sequence, and forming shoulder extending edges on both sides during the laying process; and

by means of a vulcanization plant, preparing a pre-vulcanized annular crown with shoulder extending edges by using a patterned annular mold.

Also included is a retreaded extra-large tire, where the above-mentioned annular crown is used as a structural component of the tire and is combined with the carcass of the old tire after stripping the tread and belts, and a retreaded tire is formed after vulcanization.

Also included is a new extra-large tire, where the above-mentioned annular crown is used as a structural component of the tire and is combined with pre-prepared carcass structural components, and a new tire is formed after vulcanization, and the pre-prepared structural components are freshly prepared and vulcanized, and have all the other components necessary to constitute a tire except the crown structure.

The present invention has the beneficial effects as follows:

In addition to the tread, the pre-vulcanized annular crown of an extra-large tire provided in the present invention also includes other structures, such as belts, of the tire other than the carcass, and a structure of pattern blocks and pattern grooves for extra-large tires are arranged on the shoulder extending edges. The pre-vulcanization of the crown is completed first, and then combined with the carcass for vulcanization.

1) Pre-vulcanized annular crown components of shoulder extending edges with a pattern structure according to the present invention can completely replace the original crown components of the tire to be retreaded. When the old carcass is ground, the pattern grooves on the original shoulders can be completely removed. Compared with the defects of the existing pre-vulcanized retreading technology that the original patterns cannot be completely removed or the pattern grooves need to be filled, the present invention can give full play to the structural and functional advantages of the crown after an extra-large tire is retreaded to enable the retreaded tire to have better heat dissipation, which avoids the defects of poor heat dissipation in the existing tire retreading process, and reduces the shoulder delamination and peeling phenomenon in the existing retreaded products and processes.

2) The production process of tire carcass combined with the pre-vulcanized annular crown can reduce the time for the whole tire to be vulcanized under high temperature and high pressure environment, and avoid adverse effects on the carcass structure and rubber, thereby protecting the carcass. This vulcanization production process has the same effect on new tires and retreaded tire carcasses, and is suitable for the production and manufacture of new tires and the remanufacturing of retreaded tires. Moreover, based on the pre-vulcanized tread process, the present invention can fully improve the wear resistance and anti-puncture performance of the tread part, which is better than the retreaded tires prepared by the model and the carving process, and is also better than wear resistance and puncture performance of new tires produced based on the existing new tire manufacturing process.

3) The pre-vulcanized annular crown of the present invention has a belt steel wire structure, which can replace the extra-large tires whose belt steel wires have been seriously damaged, and improves the utilization rate of old carcasses.

The scrapping of extra-large tires is mostly due to the gradual corrosion of the belt steel wire after small-scale damage, forming a gap between the belt and the tread rubber. The main steel wire, sidewall, and toe of this scrap tire are basically intact on the surface, but the tire cannot be retreaded with the current two retreading techniques. Utilizing the innovative technology of the present invention, the old carcass can be retreaded to achieve the purpose of recycling: by stripping off the damaged tread and belt steel wires remaining on the carcass, grinding the carcass to achieve matched crown shape and size of the pasting surface of the annular crown, and then performing processes such as hole repair, rubber spraying, pasting and vulcanization, the corresponding finished retreaded tire can be prepared.

4) The traveling environment of extra-large tires has many curves and steep slopes, as well as heavy vehicle load, short haul and frequent U-turns, and small turning radius of tires. Therefore, the combined effects of driving force, braking force, load and lateral force during vehicle traveling will cause a great impact on the tires. In the present invention, the pre-vulcanized annular crown has larger shoulder extending edges, which form better support and connection to the shoulders and part of the sidewall of the carcass, have the effect of structural reinforcement, and are more conducive to the transmission and digestion of force components in all directions. At the same time, the bonding area between the crown and the carcass is increased, the bonding strength is improved, and it is beneficial to the stability of the bonding structure.

5) After grinding, repairing and other processes, the carcass forms an arched profile under the action of the main steel wire, and the inner curved surfaces of the shoulder extending edges adopt multiple tangent arcs with different radii in the axial direction, which is conducive to improving the coincidence of the joint surfaces, and improves the allowable degree of shape deviation of the joint surface of the annular crown and the carcass, and is beneficial to eliminate the gap between the joint surfaces.

The inner section of the annular crown is a curve composed of multiple segments of tangent arcs, or a straight line segment with both ends tangent to the arc. The former has a large bonding area between the annular crown and the carcass, and the latter can save rubber when preparing the annular crown.

6) Sensor installation blind holes are preset in the tread. When it is necessary to install a tread sensor to monitor the use of extra-large retreaded tires, the sensor can be installed directly to improve the accuracy of the sensor installation position and work efficiency in the later stage. The blind holes on the tread correspond to the raised cylindrical structure on the vulcanization mold. The cylindrical structure is in the pattern blocks during vulcanization, which increases heat transfer points inside the tread rubber, can improve the distribution state of the heat in the tread during vulcanization, is beneficial to the vulcanization uniformity of the pattern block rubber, and reduces the vulcanization time. By setting up the sensor installation blind holes, it is convenient to use monitoring technology on an extra-large retreaded tire, which can give early warning of early failures that may occur in a certain position of the tire, timely maintenance to avoid greater risk of failure, improve the service life and security of the extra-large retreaded tire, and increase the added value of the retreaded tire.

### BRIEF DESCRIPTION OF THE DRAWINGS

FIG. 1 is a sectional view of the pre-vulcanized annular crown;

FIG. 2 is a schematic diagram of the side view appearance;

FIG. 3 is a sectional view of FIG. 1 after combining the carcass;

FIG. 4 is a schematic diagram of the side view appearance of FIG. 3;

FIG. 5 is the enlarged schematic diagram of the end of shoulder extending edges at I shown in FIG. 1,

FIG. 6 is a schematic diagram of the shoulder extending edges with the straight line segment;

FIG. 7 is a sectional view of FIG. 6 after combining the carcass;

FIG. 8 is a cross-sectional schematic view of existing pre-vulcanized tread;

FIG. 9 is a schematic diagram of rubber filling of retreaded tires produced in the prior art.

Symbols in the figures are listed as follows:

1—belt primer, 2—shoulder pad, 3—belt, 4—base rubber, 5—tread rubber, 6—belt interlayer, 7—shoulder extending edge, 8—anti-scratch line, 9—carcass, 10—blind hole, 11—middle pad rubber, and 12—cooling groove.

Instructions for size marks in the figures:

B1—the width of the traveling surface of the pre-vulcanized annular tire;

B2—the total width of the pre-vulcanized annular crown;

H1—the thickness of pre-vulcanized annular crown;

H2—section height of pre-vulcanized annular crown;

R1—the radian of the inner section body of the pre-vulcanized annular crown;

R2—the arc segment of the inner surface of the shoulder extending edges on the pre-vulcanized annular tread.

### DETAILED DESCRIPTION

In order to better understand the present invention, the following will further explain the present invention.

### Embodiment 1

This embodiment relates to a pre-vulcanized annular crown of a 59/80R63 extra-large tire, where the middle segment at the inner side of the section of the annular crown is a multi-segment arc, and the inner sides of the shoulder extending edges at both ends are arcs tangent to the middle segment.

1. After the tire is used, its size and structure are quite different from a new one. Therefore, before retreading the tire, it is necessary to inspect the main body size and crown structure size of the corresponding new tire, so as to determine the structural dimensions of the pre-vulcanized annular crown.

Parameters of a new tire are as follows:

The tire section width is 1,490 mm, the outer diameter is 4,025 mm, the width of a traveling surface is 1,300 mm, the arc radius of the traveling surface is 3,900 mm, and the pattern depth is 88 mm.

The basic size of the annular crown is the same as that of a new tire, and the other main characteristic dimensions of the annular crown are determined as follows:

Crown thickness H1 is equal to 160 mm, total height of the annular crown section H2 is equal to 350 mm, total width of the annular crown section is 1430 mm, and radius of the inner arc surface of the shoulder extending edges 7 is 350 mm.

According to the above size data, a pre-vulcanized annular crown of an extra-large tire is realized as follows:

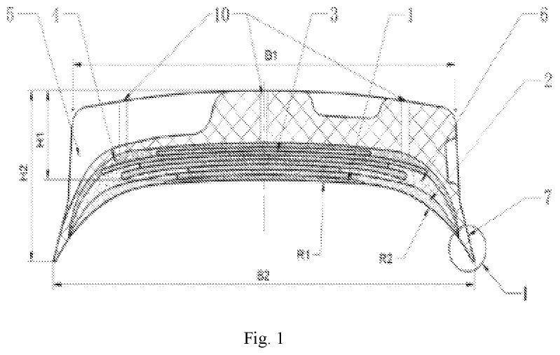

As shown in FIG. 1, the pre-vulcanized annular crown includes an annular crown and shoulder extending edges 7 on both sides of the crown, and the tread included in the crown has tread patterns suitable for extra-large tires.

The annular crown can include the common structure of the general new crown in the current prior art, namely tread rubber 5, base rubber 4, belts 3, belt interlayer 6, shoulder pad 2 and belt primer 1. The middle part of the innermost side (near the carcass side) is the belt primer 1, both sides of which are shoulder pad rubber 2, and the top of the belt primer 1 is the belts 3, the base rubber 4 and the tread rubber 5 in sequence, where two ends of the base rubber 4 are connected to two ends of the shoulder pad 2, and the belt interlayer 6 is provided there-between, and both sides of the tread rubber 5 have shoulder pattern extending edges 7 extending downward to cover the ends of the base rubber 4 and the shoulder pad 2.

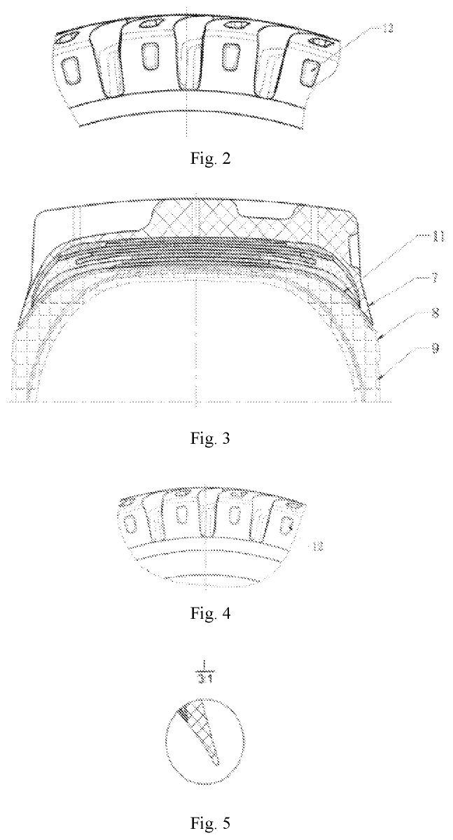

As shown in FIG. 1 and FIG. 2, the shoulder extending edges 7 have a structure of pattern block sand pattern grooves extending from a tread to sidewalls, where the convex parts are pattern blocks, and the concave parts are pattern grooves. The annular crown is provided with cooling grooves 12 on the side of the pattern blocks at the shoulders.

As shown in FIG. 1 and FIG. 3, the section of the inner surface of the annular crown is a curve composed of multiple tangent arcs, which can better fit the old carcass after grinding. The radius of the inner arc surfaces of the shoulder extending edges 7 is 350 mm, and a larger radius of the inner arc surface can improve the matching degree between the tread and the carcass. The ends of the shoulder extending edges 7 are ends of straight line blunt edges, and as shown in FIG. 5, the average thickness of the blunt edges is 6 mm, which can improve the material strength at the edges of the tread.

The width of the traveling surface of the annular crown is 1,300 mm, the radius of the arc of the traveling surface of the annular crown is 3,900 mm, and the thickness of the annular crown is 160 mm. The parameters related to the size of the tire outer edge must be consistent with the size of the new tire to match tires of the same specification.

There are six layers of the belts 3 in total, and the width of the widest layer is 1,100 mm. Starting from the innermost layer 1, the angle of the first layer is 5°, the angle of the steel wires of the second to fourth layers of belts is 20°, the angle of the steel wires of the belts of the 5th to 6th layers is 25°, and the directions of the angles between the steel wires of the two adjacent cord layers are opposite.

2. An outer tread mold with pattern grooves is used, and the preparation is completed after being vulcanized by the vulcanization device suitable for the present invention.

3. Realization of tire retreading: after removing the tread and belts from the carcass to be retreaded, pretreatments such as grinding, repairing and glue spraying are performed on the outer surface according to the size combined with the pre-vulcanized annular tread, the pre-vulcanized annular crown of this embodiment is assembled, and secondary vulcanization of the crown is performed in a suitable retreaded tire vulcanization plant.

The service life of the extra-large tire retreaded by this embodiment can reach 80%-100% of the original tire.

### Embodiment 2

This embodiment relates to a pre-vulcanized annular crown of a 59/80R63 extra-large tire, where the middle segment at the inner side of the section of the annular crown is a multi-segment arc, and the inner sides of the shoulder extending edges at both ends are arcs tangent to the middle segment.

The same parts of the new tire parameters and the main characteristic dimensions of the annular crown are referred to in embodiment 1. The difference is that the inner side of the shoulder extending edges 7 is a straight line segment tangent to the arc, with the angle between the straight line segment and the center line of the section being 35°, and the radius of the transition arc between the straight line segment and the inner surface of the crown being 100 mm.

According to the above size data, a pre-vulcanized annular crown for an extra-large tire is realized as follows:

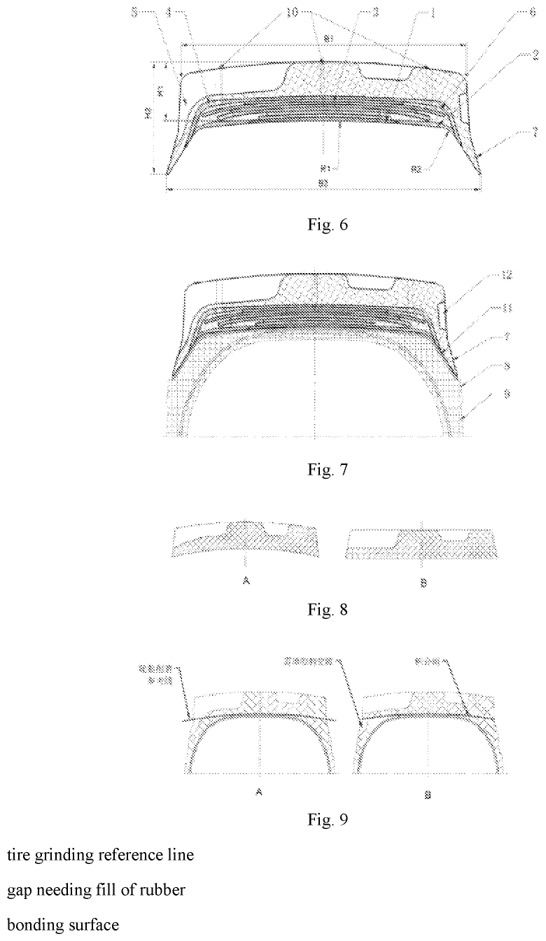

As shown in FIG. 6, the pre-vulcanized annular rubber crown includes an annular crown and shoulder extending edges 7 on both sides of the crown. The shoulder extending edges extend along the shoulders toward the center of the tire, and the tread included in the crown are provided with tread patterns suitable for extra-large tires.

Similar to embodiment 1, the annular crown includes a tread rubber 5, a base rubber 4, belts 3, a belt interlayer 6, a shoulder pad 2, and a belt primer 1, which are arranged in order from outside to inside.

As shown in FIGS. 6 and 7, the shoulder extending edges 7 are provided with a structure of pattern blocks and pattern grooves, which extend from a tread to sidewalls. The annular crown is provided with cooling grooves 12 on the sides of the pattern blocks at the shoulders.

As shown in FIGS. 6 and 7, the middle segment of the inner surface section of the annular crown is a curve composed of multiple tangent arcs, which can better fit the old carcass after grinding. The inner side of the shoulder extending edges 7 is a straight line segment tangent to the arc, the angle between the straight line segment and the section center line is 30-35°, and the radius of the transition arc of the straight line segment and the inner surface of the crown is 100 mm. The ends of the shoulder extending edges 7 are ends of straight blunt edges, as shown in FIG. 5, the thickness of the blunt edges is 6 mm, which can improve the material strength at the edge of the tread, avoid the damage of the annular tread during the turnover, and increase bonding area after the carcass is vulcanized for the second time. The width of the traveling surface of the annular crown is 1,300 mm, the radius of the arc of the traveling surface of the annular crown is 3,900 mm, and the thickness of the annular crown is 160 mm. The parameters related to the size of the outer edge of the tire must be consistent with the size of a new tire to match tires of the same specification.

There are six layers of the belts 3 in total, and the width of the widest layer is 1,100 mm. Starting from the innermost layer 1, the angle of the first layer is 5°, the angle of the steel wires of the second to fourth layers of belts is 20°, the angle of the steel wires of the belts of the 5th to 6th layers is 25°, and the directions of the angles between the steel wires of the two adjacent cord layers are opposite.

### Embodiment 3

The difference between this embodiment and embodiment 1 is that sensor installation blind holes 10 are distributed on the surface of the tread rubber, and the bottom ends of the blind holes 10 are located between the base rubber and the belts.

Preset sensor installation blind holes are added in the tread. When it is necessary to install a tread sensor to monitor the use of extra-large retreaded tires, the sensor can be installed directly without drilling holes on the tread, which can improve the accuracy of the sensor installation position and work efficiency in the later stage. The blind holes on the tread correspond to the raised cylindrical structure on the vulcanization mold. The cylindrical structure is in the pattern blocks during vulcanization, which increases heat transfer points inside the tread rubber, can improve the distribution state of the heat in the tread during vulcanization, is beneficial to the vulcanization uniformity of the pattern block rubber, improves the vulcanization quality, and reduces the vulcanization time. By setting up the sensor installation blind holes, it is convenient to use monitoring technology on an extra-large retreaded tire, which can give early warning of early failures that may occur in a certain position of the tire, timely maintenance to avoid greater risk of failure, improve the service life and security of the extra-large retreaded tire, and increase the added value of the retreaded tire.

The above description is only preferred embodiments of the present invention, but the scope of protection of the present invention is not limited thereto, any changes that can be easily conceived by those skilled in the art within the technical scope disclosed in the present invention should be covered within the scope of protection of the present invention. Therefore, the scope of protection of the present invention should be subject to by the scope of protection of the claims.

1.-13. (canceled)

14. A pre-vulcanized annular crown of an extra-large tire, wherein the extra-large tire is a pneumatic tire with a nominal diameter of 33 inches or more of a rim and a nominal width of 24 inches or more of a section, and the tire is designed that the outer diameter is 2,000 mm or more, and a single tire load is 2,000 kg or more; the extra-large tire comprises an annular crown, and shoulder extending edges extending from both sides of the crown to the central direction of the tire along shoulders, where the shoulder extending edges are provided with a structure of pattern blocks and pattern grooves, which extend from a tread to sidewalls and are suitable for the extra-large tire, outer contour lines of sections of the shoulders and the shoulder extending edges are concave inwards, the arc radius of the inner surfaces of the shoulder extending edges is 100-350 mm, the ends of the shoulder extending edges are blunt ends formed by a straight line or an arc, and the thickness of the blunt edges is 3-10 mm.

15. The annular crown according to claim 14, wherein the middle segment at the inner side of the section of the annular crown is a multi-segment arc, and the inner sides of the shoulder extending edges at both ends are arcs tangent to the middle segment, or the inner sides of the shoulder extending edges at both ends are straight line segments with a tangent arc transition to the middle segment.

16. The annular crown according to claim 14, wherein the width range of a traveling surface of the annular crown is more than 500 mm, the arc radius of the traveling surface of the annular crown is more than 2,000 mm, and the thickness of the annular crown is 100 mm-250 mm.

17. The annular crown according to claim 14, wherein the annular crown is provided with cooling grooves on the surface of the pattern blocks at the shoulders.

18. The annular crown according to claim 14, wherein multiple sensor installation blind holes are distributed on the surface of tread rubber of the annular crown, and the bottom ends of the blind holes are located between a primer and belts.

19. The annular crown according to claim 14, wherein the annular crown comprises tread rubber, the primer, and belts.

20. The annular crown according to claim 19, wherein the annular crown also comprises one or more of the following rubber layers: belt interlayer, belt primer, and shoulder pad.

21. The annular crown according to claim 19, wherein the maximum width of the belts is less than 90% of the width of the traveling surface, the number of layers of steel cords in the belts is 3-6, the acute angle formed by the steel wire of each layer of cords and the circumferential center line of the tire is 2°-35°, and the directions of the angles between the steel wires of two adjacent cord layers are opposite.

22. The annular crown according to claim 14, wherein the section height of the annular crown is 1.5-2.5 times the central thickness of the annular crown.

23. The annular crown according to claim 14, wherein the total width of the annular crown is 1.02-1.15 times the width of the traveling surface.

24. A method for preparing the pre-vulcanized annular crown of an extra-large tire according to claim 14, comprising the following steps:
measuring a new crown structure of a tire to be retreaded to obtain the main size of the tire and the characteristic size of the crown;
designing the structural components and dimensions required for the crown according to the obtained shape and size, planning the layout of the tread patterns and shoulder extending edge patterns, and designing and manufacturing a vulcanization mold with patterns;
using molding equipment to build an annular crown structure, laying each layer of structural materials in sequence, and forming shoulder extending edges on both sides during the laying process; and
by means of a vulcanization plant, preparing a pre-vulcanized annular crown with shoulder extending edges by using a patterned annular mold.

25. A retreaded extra-large tire, wherein the annular crown according to claim 14 is used as a structural component of the tire and is combined with the carcass of the old tire after stripping the tread and belts, and a retreaded tire is formed after vulcanization.

26. A new extra-large tire, wherein the annular crown according to claim 14 is used as a structural component of the tire and is combined with pre-prepared carcass structural components, and a new tire is formed after vulcanization, where the pre-prepared structural components are freshly prepared and vulcanized, and have all the other components necessary to constitute a tire except the crown structure.
